(19) United States
(12) Patent Application Publication
(10) Pub. No.: US 2024/0375627 A1
(43) Pub. Date: Nov. 14, 2024

(54) ELECTROPNEUMATIC TRAILER PARKING-BRAKE SYSTEM, TRAILER, TOWING COMBINATION

(71) Applicant: ZF CV Systems Global GmbH, Bern (CH)

(72) Inventor: Julian van Thiel, Grossburgwedel (DE)

(21) Appl. No.: 18/778,067

(22) Filed: Jul. 19, 2024

Related U.S. Application Data
(63) Continuation of application No. PCT/EP2023/050267, filed on Jan. 9, 2023.

(30) Foreign Application Priority Data
Jan. 19, 2022 (DE) 10 2022 101 141.0

(51) Int. Cl. B60T 13/68; B60T 7/20

(52) U.S. Cl. CPC B60T 13/683; B60T 7/20

(57) ABSTRACT

An electropneumatic trailer parking-brake system is for a trailer, which includes an electropneumatic trailer parking-brake module configured for releasing or engaging the electropneumatic trailer parking-brake system in dependence on an operating signal, and has: a reservoir port for receiving a reservoir pressure, a parking-brake port for connecting a parking-brake cylinder, a main-valve unit configured to deliver a spring-actuator pressure at the parking-brake port in dependence on a control pressure, and a pilot-valve arrangement for providing the control pressure. An electronic control unit is configured to receive the operating signal in the form of an electrical operating signal for releasing or engaging the electropneumatic trailer parking-brake system, and to provide an electrical switching signal to the pilot-valve arrangement in dependence on the operating signal, wherein the pilot-valve arrangement is configured to provide the control pressure in dependence on the electrical switching signal.

### CROSS-REFERENCE TO RELATED APPLICATIONS

This application is a continuation application of international patent application PCT/EP2023/050267, filed Jan. 9, 2023, designating the United States and claiming priority from German application 10 2022 101 141.0, filed Jan. 19, 2022, and the entire content of both applications is incorporated herein by reference.

### TECHNICAL FIELD

The disclosure relates, in a first aspect, to an electropneumatic trailer parking-brake system for a trailer. The disclosure relates, in a second aspect, to a trailer including an electropneumatic trailer parking-brake system according to the first aspect of the disclosure and, in a third aspect, to a towing combination including a trailer according to the second aspect of the disclosure.

### BACKGROUND

Electropneumatic parking-brake systems for commercial vehicles with trailers are commonly known. In the case of known electropneumatic parking-brake systems, pneumatic control is usually effected via a trailer control valve arranged in a commercial vehicle, that is, in the vehicle that is towing the trailer. In particular, such trailer control valves are configured to provide a spring-actuator pressure as control pressure for a pneumatic trailer parking-brake module in the trailer. Such an arrangement including a trailer control valve is disclosed, for example, in DE 10 2015 008 377 A1.

Such approaches are still in need of improvement. In particular, it is desirable to improve the operability of a trailer parking-brake system. This applies in particular to situations in which a trailer is maneuvered when uncoupled. It would also be desirable to have a way of controlling a trailer parking-brake system electrically or electronically. Such a possibility for electric or electronic control would advantageously improve the controllability of the trailer, in particular in the case of automated, autonomous or semi-autonomous driving functions of the trailer or the towing combination.

### SUMMARY

It is an object of the disclosure to specify an improved electropneumatic trailer parking-brake system for a trailer. In particular, it is intended to improve the operability of a trailer parking-brake system and/or to provide a way of electrically or electronically controlling the trailer parking-brake system.

The object, relating to the electropneumatic trailer parking-brake system, is achieved by the disclosure with an electropneumatic trailer parking-brake system for a trailer. The electropneumatic trailer parking-brake system includes: an electropneumatic trailer parking-brake module configured for releasing or engaging the electropneumatic trailer parking-brake system in dependence upon an operating signal; the electropneumatic trailer parking-brake module having a reservoir port, a parking brake port, a main-valve unit, a pilot-valve unit, a pilot-valve arrangement, and an electronic control unit; the reservoir port being configured to receive a reservoir pressure; the parking-brake port being for connecting at least one parking-brake cylinder; the main-valve unit being configured to receive the reservoir pressure and to deliver a spring-actuator pressure at the parking-brake port in dependence upon a control pressure present at a control port; the pilot-valve arrangement being configured to receive the reservoir pressure for providing the control pressure; the electronic control unit being configured to receive the operating signal in a form of an electrical operating signal for releasing or engaging the electropneumatic trailer parking-brake system, and to provide an electrical switching signal to the pilot-valve arrangement in dependence upon the operating signal; and, the pilot-valve arrangement being configured to provide the control pressure in dependence upon the electrical switching signal.

The disclosure is based on an electropneumatic trailer parking-brake system for a trailer, which includes an electropneumatic trailer parking-brake module, wherein the electropneumatic trailer parking-brake module is configured for releasing or engaging the electropneumatic trailer parking-brake system in dependence on an operating signal, and has: a reservoir port for receiving a reservoir pressure, at least one parking-brake port for connecting at least one parking-brake cylinder, a main-valve unit that receives the reservoir pressure and is configured to deliver a spring-actuator pressure at the parking-brake port in dependence on a control pressure present at a control port, and a pilot-valve arrangement that receives the reservoir pressure, for providing the control pressure.

According to the disclosure, provided in the case of the electropneumatic trailer parking-brake system is a an electronic control unit, which is configured to receive the operating signal in the form of an electrical operating signal for releasing or engaging the electropneumatic trailer parking-brake system, and to provide an electrical switching signal to the pilot-valve arrangement in dependence on the operating signal, wherein the pilot-valve arrangement is configured to provide the control pressure in dependence on the electrical switching signal.

The disclosure includes the knowledge that, via an ability to control the electropneumatic trailer parking-brake module electronically, improved possibilities for controlling the electropneumatic trailer parking-brake system are available. Since an electronic control unit is provided in the trailer parking-brake module and, in particular, is pneumatically independent of parking brake means such as, for example, trailer control valves in the towing vehicle, the electrical operating signal enables so-called by-wire controllability, that is, electrical or electronic controllability, of the trailer parking-brake system, independently of a parking-brake system of the towing vehicle.

Releasing the electropneumatic trailer parking-brake system involves, in particular, air being supplied to the spring brake cylinders by a spring-actuator pressure. Engaging the electropneumatic trailer parking-brake system involves, in particular, air being exhausted from the spring brake cylinders.

Provided in an embodiment is a trailer operating unit, for providing the operating signal. This embodiment includes the knowledge that the operability of the trailer parking-brake system may be further improved by the provision of a trailer operating unit. Via the trailer operating unit, operating signals for controlling the trailer parking-brake system may be provided, in particular independently of a parking-brake system of the towing vehicle. The operating unit is preferably arranged on the trailer, particularly preferably at a site accessible from the outside. In other embodiments, the operating unit is arranged in the commercial vehicle, that is, in the vehicle that is towing the trailer. It is therefore advantageously also possible, for example, to operate the trailer parking-brake system even when the trailer is uncoupled.

Preferably, the electrical operating signal is an electronic operating signal. In an embodiment, the electrical control unit has a wired or wireless interface for receiving the electrical operating signal from a further electrical or electronic control device.

Preferably, the trailer operating unit has an electronic operating element that is connected or connectable in a signal-carrying manner to the electrical control unit for the purpose of providing the electrical operating signal. The electronic operating element preferably includes an electronic indicator means, in particular a display screen, a light or similar means of indication, and/or input means, in particular keys, switches or similar input means for generating the electrical operating signal. Preferably, the indicator means and the input means may be combined, for example in the form of a touch screen.

In an embodiment, it is provided that the electronic operating element includes a parking-brake switch. The parking-brake switch is preferably realized as an electrical or electronic parking-brake switch for providing the electrical operating signal in dependence on a manual actuation.

Preferably, the trailer operating unit has a pneumatic operating element that is pneumatically connected or connectable to the electropneumatic trailer parking-brake module for the purpose of providing a pneumatic operating signal, particularly preferably a release pressure. Preferably, the pneumatic operating element is pneumatically connected or connectable to the pilot-valve arrangement and/or to the control port.

Various embodiments are developed further in that the electropneumatic trailer parking-brake system has a pressure sensor that is pneumatically connected to the reservoir port, for the purpose of sensing the reservoir pressure deliver at the reservoir port. A pressure sensor that is pneumatically connected to the reservoir port advantageously enables the breaking-off of a trailer reservoir line or the like to be detected. Particularly advantageously, such detection makes it possible for the trailer to be brought into a safe state in a controlled manner. In comparison with emergency braking caused by an uncontrolled collapsing of the spring brake cylinder, an embodiment that includes a pressure sensor offers the possibility of controlled, in particular electronically controlled, braking. Controlled braking may be effected, for example, by a trailer operating system or a time-controlled removal of air from the spring brake cylinders by the electropneumatic trailer parking-brake system. Particularly advantageously, emergency braking may be triggered by activation, in particular intermittent or gradually progressive activation, or energizing, of a holding valve of the pilot control arrangement.

Particularly preferably, the trailer operating unit can realized be as an assembly including the electronic operating element and having an integral or modular housing. Preferably, the trailer operating unit includes at least two housing modules that can be connected, preferably flanged together. An integral or modular housing advantageously makes it possible to achieve a compact configuration and effective protection of the trailer operating unit. Preferably, the electronic operating element and a manually actuatable valve are arranged in the assembly.

In an embodiment, it is provided that the electropneumatic trailer parking-brake system includes a manually actuatable valve, wherein the manually actuatable valve has: a manual actuator/actuating means for switching over the manually actuatable valve at least between a first valve position and a second valve position, a first valve port, which is configured to receive the reservoir pressure, and a second valve port, which is pneumatically connected to the control port for the purpose of providing a release pressure, wherein, when the manually actuatable valve is in the first valve position, the first valve port is pneumatically connected to the second valve port for the purpose of applying the reservoir pressure as release pressure to the control port. A manually actuatable valve advantageously enables a pneumatic operating signal to be provided in the form of the release pressure. This advantageously provides a pneumatic option for activating the electropneumatic trailer parking-brake module, in particular in addition to the electrical operating signal. A manually actuatable valve advantageously makes it possible to activate the trailer parking-brake module even in an electrically passive state, that is, when the trailer parking-brake module is not receiving an electrical supply. Preferably, the assembly includes the manually actuatable valve. Preferably, the first valve port of the manually actuatable valve is pneumatically connected to the reservoir port for the purpose of receiving the reservoir pressure.

Various embodiments are developed further in that the manually actuatable valve is a 3/2-way valve having an exhaust port that exhausts air into the environment, wherein the 3/2-way valve can be switched over between the first valve position and the second valve position, wherein in the first valve position the first valve port is pneumatically connected to the second valve port and preferably the exhaust port is blocked, and in the second valve position the second valve port is pneumatically connected to the exhaust port and preferably the first valve port is blocked.

Preferably, it is provided that the manual actuator/actuating means includes a push-pull element that can be moved in an axial direction for the purpose of actuating the manually actuatable valve. Such a so-called push-pull valve advantageously enables the manually actuatable valve may advantageously be easily switched over manually between two valve positions, or defined states, namely a first valve position with a first state in which the electropneumatic trailer parking-brake system is released, and a second valve position with a second state in which the electropneumatic trailer parking-brake system is engaged.

In an embodiment, it is provided that the manually actuatable valve has a pneumatic actuating means having a pneumatic switching inlet for receiving a switch-over pressure via a pneumatic switching path, wherein the pneumatic actuating means is configured to switch over the manually actuatable valve at least from the first valve position to the second valve position in dependence on the switch-over pressure. A pneumatic actuating means advantageously renders possible a pneumatic reset function, via which the mechanically actuatable valve can be switched pneumatically, preferably via a pneumatic path of the electropneumatic trailer parking-brake module. Preferably, the pneumatic actuating means is configured to switch the manually actuatable valve into the exhausted second valve position.

Preferably, the manually actuatable valve and/or the trailer operating unit have/has an indicator for indicating the valve position.

Various embodiments are developed further in that the pneumatic switching path is connected to a pilot path for the purpose of receiving the control pressure, wherein the pilot path pneumatically connects the pilot-valve arrangement and the control port. In such an embodiment, the control pressure can advantageously be provided as a switch-over pressure at the pneumatic actuating means. Via such an arrangement, the delivering of a control pressure on the pilot path advantageously enables the manually actuatable valve to be switched into the second valve position that exhausts air from the control port of the main-valve unit.

In an embodiment, it is provided that there is an electrically controllable switching valve arranged in the pneumatic switching path for the purpose of controllably connecting and closing the pneumatic switching path, wherein the pneumatic switching path is pneumatically connected to the parking-brake port for the purpose of receiving the spring-actuator pressure, or the pneumatic switching path is pneumatically connected to the reservoir port for the purpose of receiving the reservoir pressure. An electrically controllable switching valve enables the manually actuatable valve to be actuated in a more controllable manner via the pneumatic actuating means. Preferably, the switching valve is realized as a 3/2-way valve having a first switching-valve port that is pneumatically connected to the parking-brake port or to the reservoir port, and a second switching-valve port that is pneumatically connected to the pneumatic switching input, and a third switching-valve port that is pneumatically connected to an exhaust port, wherein in a first switching-valve position the first switching-valve port is pneumatically connected to the second switching-valve port, and in a second switching-valve position the second switching-valve port is pneumatically connected to the third switching-valve port.

Various embodiments are developed further in that the second valve port of the manually actuatable valve is pneumatically connected to the control port via an anti-compound port, and/or the second valve port is pneumatically connected to the anti-compound port via a select-high release valve, in such a way that whichever of the second valve port and the anti-compound port at which the higher pressure is present is connected to the control port. In such an embodiment, an existing anti-compound port can be used, advantageously, to additionally connect the manually actuatable valve pneumatically to the control port of the main valve unit.

Preferably, the anti-compound port can be pneumatically connected to the control port via a select-high shuttle valve in such a way that whichever of the anti-compound port and a pilot path at which the higher pressure is present is connected to the control port. In various embodiments, the electropneumatic trailer parking-brake module includes a select-high release valve and a select-high shuttle valve.

Preferably, it can be provided that the second valve port of the manually actuatable valve is pneumatically connected to the control port via the pilot-valve arrangement. In such an embodiment, the provision of the release pressure, that is, the pneumatic operating signal, can additionally be effected in dependence on the pilot-valve arrangement.

Preferably, the pilot-valve arrangement can have a bistable valve and/or a monostable holding valve. Preferably, the bistable valve is a 3/2-way solenoid valve that can be controlled electrically in dependence on a first electrical switching signal. Preferably, the bistable valve is a permanent-magnet type bistable valve. Preferably, the holding valve is a 2/2-way solenoid valve that is electrically controllable in dependence on a second electrical switching signal, and that is open in the non-activated state.

To achieve the object, the disclosure leads, in a second aspect, to a trailer, preferably for a commercial vehicle, having at least one parking-brake cylinder and an electropneumatic trailer parking-brake system according to the first aspect of the disclosure. In an embodiment of the trailer, it is provided that the trailer operating unit is arranged on the trailer.

To achieve the object, the disclosure leads, in a third aspect to a towing combination including a commercial vehicle and a trailer according to the second aspect of the disclosure, wherein the trailer operating unit is arranged on the commercial vehicle.

It is to be understood that the electropneumatic trailer parking-brake system according to the first aspect of the disclosure, the trailer according to the second aspect of the disclosure and the towing combination according to the third aspect of the disclosure have the same and similar sub-aspects. In this respect, for the embodiment of one aspect of the disclosure, reference is also made to the embodiments of the other aspects of the disclosure.

### BRIEF DESCRIPTION OF DRAWINGS

The invention will now be described with reference to the drawings wherein:

FIG. 1 shows a first embodiment of an electropneumatic trailer parking-brake system;

FIG. 2 shows a second embodiment of an electropneumatic trailer parking-brake system;

FIG. 3 shows a third embodiment of an electropneumatic trailer parking-brake system;

FIG. 4 shows a fourth embodiment of an electropneumatic trailer parking-brake system; and,

FIG. 5 shows a towing combination with a trailer, which includes an electropneumatic trailer parking-brake system.

### DETAILED DESCRIPTION

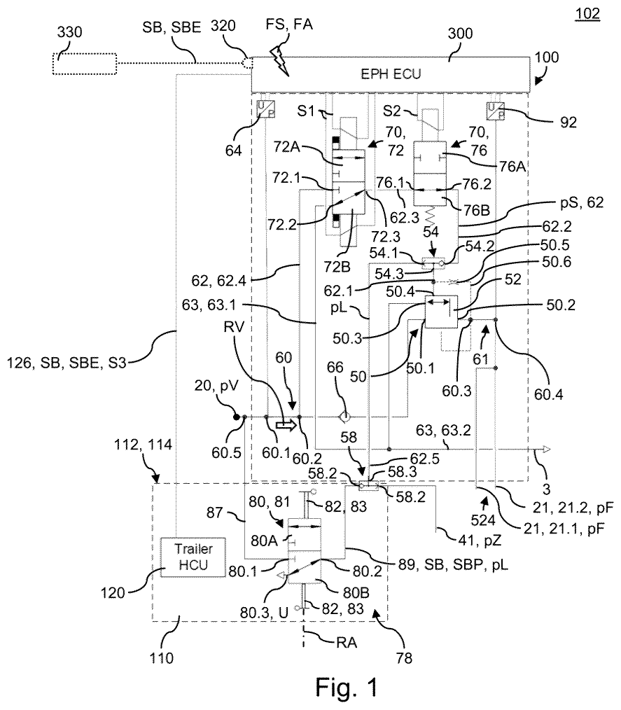

FIG. 1 shows a first embodiment of an electropneumatic trailer parking-brake system 102 that has an electropneumatic trailer parking-brake module 100.

A reservoir port 20, to which a main line 60 is connected, is configured to receive a reservoir pressure pV for the electropneumatic trailer parking-brake module 100. Further along the main line 60 in a supply direction RV, a pressure sensor 64 is pneumatically connected via a first main-line branch 60.1 to the main line and thus to the reservoir port 20, for the purpose of determining the reservoir pressure pV.

Further along the main line 60 in the supply direction RV, an electropneumatic pilot-valve arrangement 70 is pneumatically connected to the main line 60 via a second main-line branch 60.2. Arranged further along the main line 60 in the supply direction RV there is a main-line non-return valve 66 that is configured to open in the supply direction, that is, in the direction of compressed air flowing from the reservoir port 20 into the main line 60, and to block in the opposite direction. Due to the main-line non-return valve 66, the reservoir pressure pV can advantageously be prevented from being released from a main-valve unit 50, in particular in the event of the breaking-off of a reservoir end coupling.

Connected to the main-line non-return valve 66 in the supply direction RV is the main-valve unit 50, including a relay valve 52, which is connected to the main line 60 via a first main-valve port 50.1. The relay valve 52 is configured to pneumatically connect the first main-valve port 50.2 and a second main-valve port 50.2 by pressurizing a control port 50.4 with a control pressure pS, in order thus to deliver a spring-actuator pressure pF at the second main-valve port 50.2 in dependence on the control pressure pS. The second main-valve port 50.2 is in turn connected to a second main-line portion 61 of the main line 60.

The second main-valve port 50.2 is pneumatically connected to the control port 50.4 via a third main-line branch 60.3 and a pneumatic self-holding path 50.6, which has a throttle 50.5. The pneumatic port, due to the throttle 50.5, which has a relatively small nominal width, is configured, in the event of a leakage-related drop in pressure at the control port 50.4, to equalize this pressure back to the level of the delivered spring-actuator pressure pF by a relatively slow replenishing flow.

The second main-line portion 61 is connected, via a fourth main-line branch 60.4, to a further pressure sensor 92 for the purpose of determining the spring-actuator pressure pF. The second main-line portion 61—in order provide the spring-actuator pressure pF—is connected to a parking-brake port 21, in this case a first parking-brake port 21.1 and a second parking-brake port 21.2.

From the second main-line branch 60.2, a fourth control-line portion 62.4 connects a pilot path 62 of the main line 60 to a first bistable-valve port 72.1 of a bistable valve 72 of the pilot-valve arrangement 70.

The bistable valve 72 of the pilot-valve arrangement 70 is realized as a bistable 3/2-way solenoid valve, which is shown here in an exhaust position 72B, in which a third bistable-valve port 72.3 is pneumatically connected to the second bistable-valve port 72.2 for the purpose of removing air from the pilot path 62. In an air inlet position 72A—not shown here—the bistable valve 72 is configured to establish a pneumatic port between the first bistable-valve port 72.1 and the third bistable-valve port 72.3, in order to provide the reservoir pressure pV in the pilot path 62. The bistable valve 72 can be switched over between the air inlet position 72A and the exhaust position 72B in dependence on a first electrical switching signal S1.

The pilot-valve arrangement 70 has a holding valve 76. The third bistable-valve port 72.3 is connected to a first holding-valve port 76.1 of the holding valve 76 via a third control-line portion 62.3 of the pilot path 62. The pilot-valve arrangement 70 may be realized as one structural unit, but it is nevertheless also possible for the bistable valve 72 and the holding valve 76 to be realized as independent components.

In the present case, the holding valve 76 is realized as a normally open, 2/2-way solenoid valve and is shown here in its release position 76B, in which the first holding-valve port 76.1 is pneumatically connected to a second holding-valve port 76.2. In a holding position 76A, which is the case when the holding valve 76 is energized, that is, when a second electrical switching signal S2 is present, the pneumatic port between the first holding-valve port 76.1 and a second holding-valve port 76.2 is disconnected. The holding valve 76 is monostable and when in the non-activated state, that is, when no second electrical switching signal S2 is present, switches independently into the release position 76B.

A second control-line portion 62.2 of the pilot path 62 is connected to the second holding-valve port 76.2. The second control-line portion 62.2 is in turn pneumatically connected to a second shuttle-valve port 54.2 of a select-high shuttle valve 54.

Connected to the third shuttle-valve port 54.3 is first control-line portion 62.1 of the pilot path 62, which in turn is pneumatically connected to the control port 50.4 of the relay valve 52. The relay valve 52 can be activated—for the purpose of delivering the spring-actuator pressure pF at the third main-valve port 50.3—as a result of the control port 50.4 being acted upon.

With the select-high shuttle valve 54 in the configuration shown here, it is always whichever of the first and second shuttle-valve port 54.1, 54.2 at which the higher pressure prevails that is pneumatically connected to the third shuttle-valve port 54.3. Thus, in accordance with the principle of operation of a shuttle valve, the respectively other shuttle valve port 54.1, 54.2 is blocked by the valve body.

A first exhaust-line portion 63.1 of an exhaust line 63 is connected to the second bistable-valve port 72.2 of the bistable valve 72. When the bistable valve is in an exhaust position 72B, the third bistable-valve port 72.3 is pneumatically connected to the second bistable-valve port 72.2. In this exhaust position 72B, the third control-line portion 62.3 of the pilot path 62 is thus pneumatically connected to the first exhaust-line portion 63.1.

Connected to the first exhaust-line portion 63.1 is a second exhaust-line portion 63.2, which in turn is connected to an exhaust port 3 of the electropneumatic trailer parking-brake module 100. A third exhaust-line portion 63.3 connects the first main-valve port 50.1 of the main-valve unit 50, or of the relay valve 52, to the exhaust line 63, and consequently to the exhaust port 3.

With a system shown in FIG. 1, it is possible to provide a fail-safe braking functionality, that is, a functionality for braking a vehicle if there is an electric power failure or a fault signal from a control unit 300. Provision of the fail-safe braking functionality is effected by maintaining a control pressure pS at the control port 50.4 of the relay valve, via which air is supplied to at least one spring-brake cylinder 524 in order to release the parking brake. If a fail-safe braking situation occurs, in particular if there is an electric power failure or a fault signal from the electronic control unit 300, exhausting of the control port 50.4 is accordingly effected by exhausting of the spring-brake cylinder 524, in order to activate the parking brake. The control pressure pS may be provided in the form of the supplementary control pressure pZ via an anti-compound port 41.

The exhausting the control port 50.4 can be achieved via the holding valve 76, which is automatically de-energized and opens in the event of an electric power failure FS or a fault FA from the electronic control unit 300.

Owing to the provision of a select-high shuttle valve 54, air can also be supplied to the control port 50.4 of the relay valve 52, in particular pressurized with a control pressure pS or a supplementary control pressure pZ or a release pressure pL, when the bistable valve 72 is in the exhaust position 72B.

As a result of the holding valve 76 and the select-high shuttle valve 54 being combined, air can in particular be inlet to and exhausted from the control port 50.4 of the relay valve 52, without the bistable valve 72 having to be switched into the air inlet position 72A.

This combination advantageously avoids a situation in which an electric power failure or a fault signal from the control unit 300 occurs at a time point in which the bistable valve 72 is still in the exhaust position 72A and thus exhausting of the control port 50.4 in order to produce fail-safe braking would not be possible, because in this case no pneumatic connection could be established between the control port 50.4 and the exhaust port 3.

The select-high shuttle valve 54 may be used to connect a further, alternative compressed-air source to the control port 50.4 in order to actuate the relay valve 52. For this purpose, in this case an anti-compound port 41 is pneumatically connected to the first shuttle valve port 54.1 via a fifth control-line portion 62.5.

The fifth control-line portion 62.5 connects the first shuttle-valve port 54.1 to a third release-valve port 58.3 of a select-high release valve 58.

The anti-compound port 41 for receiving a supplementary control pressure pZ is pneumatically connected to a second release-valve port 58.2. A first release-valve port 58.1 is connected, via a pneumatic operating control line 89, to a second valve port 80.2 of a manually actuatable valve 80 for the purpose of receiving a pneumatic operating signal SBP in the form of a release pressure pL.

With the select-high release valve 58, it is always whichever of the first and second release valve port 58.1, 58.2 at which the higher pressure prevails that is pneumatically connected to the third release-valve port 58.3. Thus, in accordance with the principle of operation of a shuttle valve, the respectively other release-valve port 58.1, 58.2 is blocked by the valve body.

According to a concept of the disclosure, the electropneumatic trailer parking-brake module 100 has a trailer operating unit 110. The trailer operating unit 110 is realized as an assembly 112 having a housing 114, which includes both an electronic operating element 120 and a pneumatic operating element 78 that has a manually actuatable valve 80.

For the purpose of providing an operating signal SB, namely an electrical operating signal SBE in the form of a third electrical switching signal S3, the electronic operating element 120 is connected in a signal-carrying manner, via an electrical operating control line 126, to the electronic control unit 300 of the electropneumatic trailer parking-brake module 100.

The manually actuatable valve 80 of the pneumatic operating element 78 is realized as a 3/2-way valve 81 that can be switched over between a first valve position 80A and a second valve position 80B via a manual actuating means 82, which in the present case is realized as a push-pull element 83. The push-pull element 83 is a manually adjustable switch that can be moved via a pulling or pushing movement in an axial direction RA for the purpose of switching the manually actuatable valve 80.

The manually actuatable valve 80 has a first valve port 80.1, which is connected to a fifth main-line branch 60.5 of the pneumatic main line 60 via a pneumatic operating supply line 87. The fifth main-line branch 60.5 is arranged in the main line 60 between the reservoir port 20 and the first main-line branch 60.1. The manually actuatable valve 80 has an exhaust port 80.3, which exhausts into an environment U.

In the first valve position 80A, the first valve port 80.1 is pneumatically connected to the second valve port 80.2, such that the reservoir pressure pV is provided as the release pressure pL, via the pneumatic operating control line 89, as well via as the fifth and the first control-line portion 62.5, 62.1, at the control port 50.4.

In the second valve position 80B, the second valve port 80.2 is connected to the exhaust port 80.3, such that the control port 50.4 is not acted upon by the release pressure pL and, in particular, is exhausted.

As a result of switching into the first valve position 80A, the trailer parking-brake system 102 can be brought into a released state for the purpose of moving a trailer 201, not represented here. As a result of switching into the second valve position 80B, the trailer parking-brake system 102 can be brought into an engaged state, in which the trailer 201 is in a braked state.

In optional embodiments, the electronic control unit 300 may have, in addition or as an alternative to the electronic operating element 120, a wired or wireless electrical or electronic interface 320 that is configured to receive an electrical operating signal SBE from a further electrical or electronic control device 330. The further electronic control device 330 may preferably be arranged in a towing vehicle realized as a commercial vehicle 202. In other embodiments, the electronic control device 330 may be configured differently, for example as a mobile terminal.

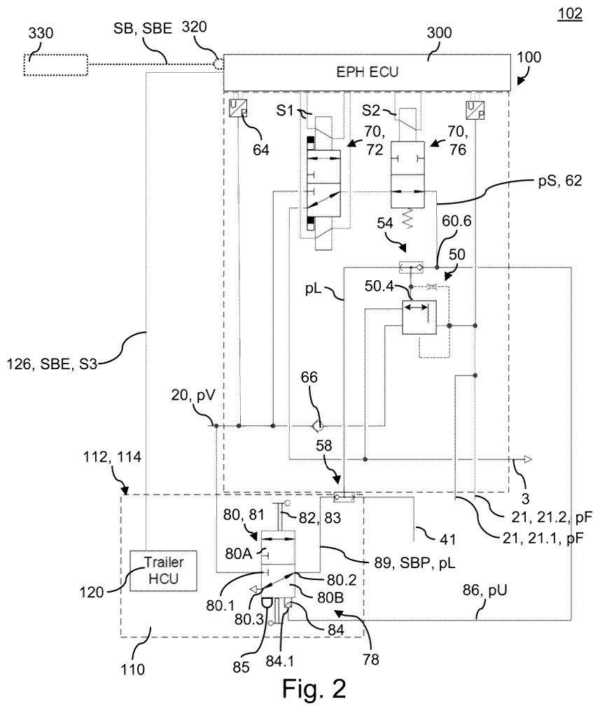

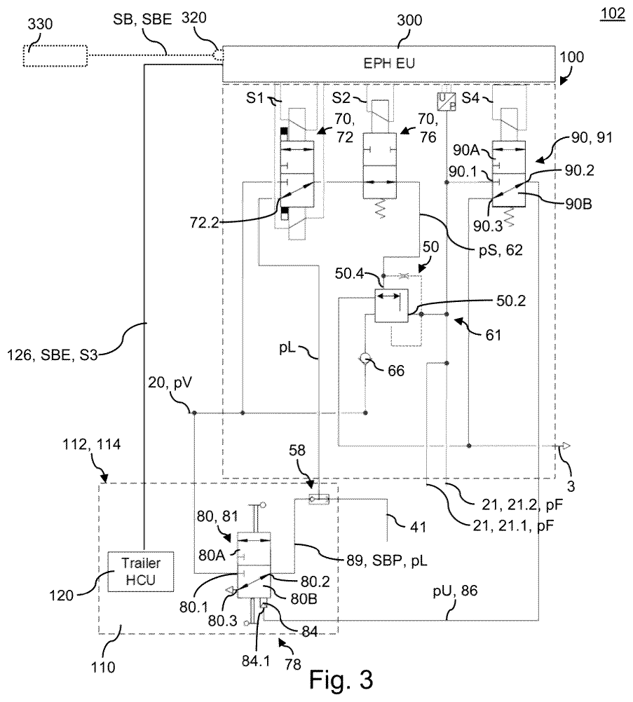

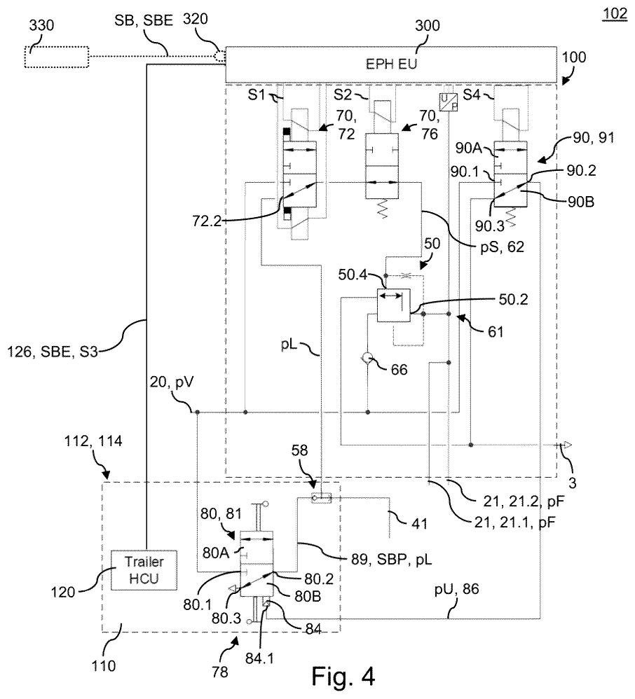

FIG. 2, FIG. 3 and FIG. 4 show further embodiments of the disclosure; for parts of the embodiments that are identical or similar, reference is made to the descriptions of FIG. 1 and, in particular, the descriptions are not repeated.

FIG. 2 shows a further embodiment of an electropneumatic trailer parking-brake system 102. Unlike the embodiment shown in FIG. 1, in the trailer parking-brake module 100 shown here the manually actuatable valve 80 has a pneumatic actuating means 84. The pneumatic actuating means 84 allows the manually actuatable valve 80—in addition to the manual actuating means 82—to be switched pneumatically. The pneumatic actuating means 84 has a pneumatic switching inlet 84.1 for receiving a switch-over pressure pU. The pneumatic switching inlet 84.1 is connected to the pilot path 62 via a pneumatic switching path 86 on a sixth main-line branch 60.6. A control pressure pS prevailing in the pilot path 62 can therefore be provided as a switch-over pressure pU at the pneumatic switching inlet 84.1. The sixth main-line branch 60.6 is arranged in the pilot path 62 between the holding valve 76 and the select-high shuttle valve 54. When a switch-over pressure pU is present at the pneumatic switching inlet 84.1, the manually actuatable valve 80 switches into the second valve position 80B. Via the pneumatic actuating means 84, the manually actuatable valve 80—in addition to being actuated manually—can advantageously be actuated pneumatically.

Advantageously, the manually actuatable valve 80 has an indicator means 85 that is configured to indicate the current valve position 80A, 80B of the manually actuatable valve 80. The indicator means 85 may be in the form of a mechanical display, for example having a sliding pin, rotary indicator or the like, preferably a clearly discernible indicator.

FIG. 3 shows a third embodiment of an electropneumatic trailer parking-brake module 100. Unlike the second embodiment shown in FIG. 2, the electropneumatic trailer parking-brake module 100 represented here has an electrically controllable switching valve 90 in the pneumatic switching path 86 for controllably connecting and interrupting the pneumatic switching path 86. The electrically controllable switching valve 90 is realized as a 3/2-way valve 91 having a first switching-valve port 90.1, a second switching-valve port 90.2 and a third switching-valve port 90.3. As a further difference compared to the second embodiment shown in FIG. 2, in this case the pneumatic switching path 86 is not pneumatically connected to the pilot path 62, but to the parking-brake port 21 or the second main-valve port 50.2. Consequently, the spring-actuator pressure pF is provided as switch-over pressure pU at the pneumatic switching inlet 84.1. The third switching-valve port 90.3 is pneumatically connected to the exhaust port 3 of the electropneumatic trailer parking-brake module 100.

The electrically controllable switching valve 90 can be switched over between a first switching-valve position 90A and a second switching-valve position 90B in dependence on a fourth electrical switching signal S4 from the electronic control unit 300. In the first switching-valve position 90A, the first switching-valve port 90.1 is pneumatically connected to the second switching-valve port 90.2, such that a spring-actuator pressure PF delivered at the second main-valve port 50.2 is provided as a switch-over pressure pF at the pneumatic switching inlet 84.1. In the second switching-valve position 90B, the second switching-valve port 90.2 is pneumatically connected to the third switching-valve port 90.3, such that the pneumatic switching inlet 84.1 is exhausted via the exhaust port 3.

As a further difference compared to the second embodiment shown in FIG. 2, in this case the second valve port 80.2 of the manually actuatable valve 80 is pneumatically connected to the control port 50.4 via the pilot-valve arrangement 70. The second valve port 80.2 is connected to the second bistable-valve port 72.2. Consequently, the release pressure pL is directed to the control port 50.4 via the bistable valve 72 and the holding valve 76 when the manually actuatable valve 80 is in its first valve position 80A. The control port 50.4 can also be exhausted via this path when the manually actuatable valve 80 is in its second valve position 80B.

FIG. 4 shows a fourth embodiment of an electropneumatic trailer parking-brake module 100, in which, compared to the third embodiment shown above, the electrically controllable switching valve 90 is connected to the pneumatic main line 60, and thus to the reservoir port 20. Consequently, the reservoir pressure pV is provided as switch-over pressure pU at the pneumatic switching inlet 84.1, in dependence on the fourth electrical switching signal S4. It is therefore possible to provide the switch-over pressure pU in a way that is substantially independent of the pilot-valve arrangement 70.

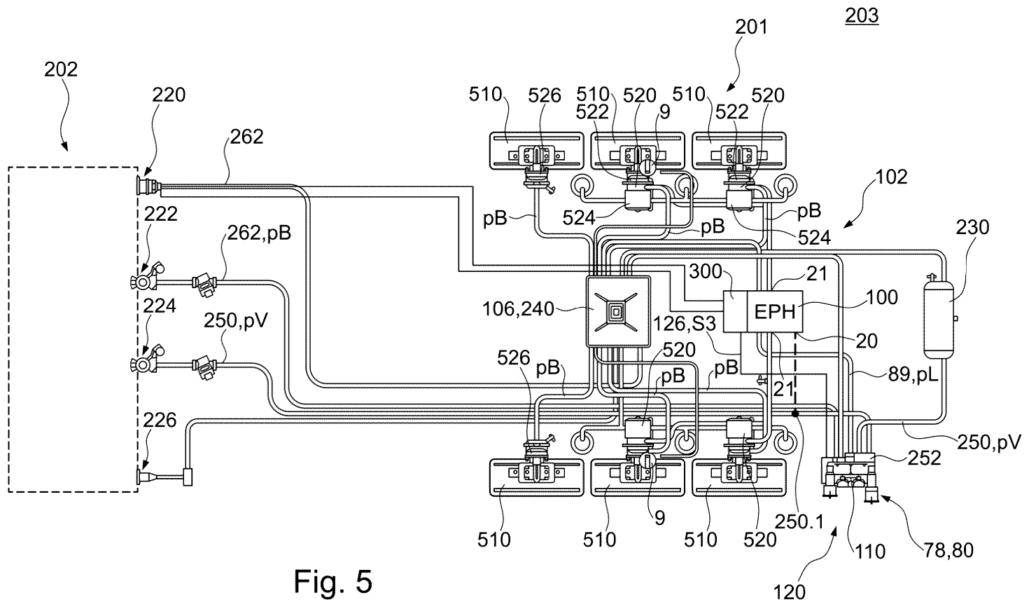

Shown schematically in FIG. 5 is a towing combination 203 including a commercial vehicle 202, as the towing vehicle, and a trailer 201. The trailer 201 has an electropneumatic trailer parking-brake system 102 including an electropneumatic trailer parking-brake module 100.

The trailer 201 includes a reservoir end coupling 224 for connecting a pneumatic trailer reservoir line 250 of the trailer 201 to a compressed-air supply system, not represented here, of the commercial vehicle 202 for the purpose providing compressed air. The pneumatic loads of the trailer 201, in particular the trailer parking-brake system 102 and a trailer service-brake system 106, are supplied with the reservoir pressure pV via the trailer reservoir line 250. At a first trailer reservoir-line branch 250.1, the trailer reservoir line 250 is connected to a reservoir port 20 of the electropneumatic trailer parking-brake module 100 in order to supply it with the reservoir pressure pV. As a result of the electropneumatic trailer parking-brake module 100 being directly connected in such a manner to the reservoir end coupling 224, in particular without a non-return valve or the like, it is advantageously ensured that in the event of breaking-off of the reservoir end coupling 224, and in particular additionally of a control end coupling 220, the pressure at the reservoir port 20 drops as a safety measure and thus the control port 50.4 of the main valve unit 50 is exhausted in the event of the spring-brake cylinder 524 collapsing. The trailer reservoir line 250 is further pneumatically connected to a compressed-air reservoir 230 and further to a trailer service-brake module 240.

The trailer 201 includes a service-brake end coupling 222 for connecting a pneumatic service-brake line 260 to a service-brake system, not represented here, of the commercial vehicle 202 for the purpose of receiving a service-brake pressure pB. The service-brake pressure pB is provided, in particular as control pressure, to the trailer service-brake module 240.

The control end coupling 220 is configured to connect at least one electrical trailer control line 262 to at least one electrical vehicle control unit, not represented here, of the commercial vehicle 202. A number of electrical or signaling sources may thus be connected to a number of electrical or signaling receivers via the control end coupling 220, for example to enable a power supply to the trailer 201 or a signal exchange for brake lights, the service brake system or further vehicle systems. In particular, via the control end coupling 220, electrical signals may be provided to and/or received from the trailer service-brake module 240 and/or the electrical control unit 300 of the electropneumatic trailer parking-brake module 100.

The towing combination 203 may have further end couplings, such as here an additional electrical supply end coupling 226 for supplying the trailer service-brake module 240.

The trailer 201 has in total six wheels 510, with two wheels 510 each having a service-brake cylinder 526 and four wheels 510 each having a combination brake cylinder 520. A combination brake cylinder 520 in each case has a service-brake chamber 522, which is pneumatically connected to the trailer service-brake module 240, and a spring-brake chamber 524, which is pneumatically connected to the trailer parking-brake module 100. Nevertheless, the electropneumatic trailer parking-brake system 102 may also have a spring-brake cylinder 524 instead of a combination brake cylinder 520.

The electropneumatic trailer parking-brake system 102 includes a trailer operating unit 110 according to the concept of the disclosure. The trailer operating unit 110 includes an electronic operating element 120 for providing a third electrical switching signal S3 to the electronic control unit 300 of the electropneumatic trailer parking-brake module 100. The trailer operating unit 110 further includes a manually actuatable valve 80 for providing a release pressure pL to the electropneumatic trailer parking-brake module 100.

Optionally, the trailer operating unit 110 may have further pneumatic valve elements as shown here, for example a non-return valve 252 for the trailer reservoir line 250 in order to protect the pressure reservoir 230, in particular in the event of the reservoir end coupling 224 breaking off.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS (PART OF THE DESCRIPTION)

3 exhaust port
20 reservoir port
21 parking-brake port
41 anti-compound port, supplementary brake pressure port
50 main-valve unit
50.1-50.3 first to third main-valve port
50.4 control port
50.5 throttle
50.6 pneumatic self-holding path
52 relay valve
54 select-high shuttle valve
54.1-54.3 first to third shuttle-valve port of the select-high shuttle valve
58 select-high release valve
58.1-58.3 first to third release-valve port of the select-high release valve
60 main line
60.1-60.6 first to sixth main-line branch
61 second main-line portion
62 pilot path
62.1-62.5 first to fifth control-line portion
63 exhaust line
63.1-63.3 first to third exhaust-line portion
64 pressure sensor
66 main-line non-return valve
70 pilot-valve arrangement
72 bistable valve
72.1-72.3 first to third bistable-valve port
72A air inlet position of the bistable valve
72B exhaust position of the bistable valve
76 holding valve
76.1, 76.2 first, second holding-valve port
76A holding position of the holding valve
76B release position of the holding valve
78 pneumatic operating element
80 manually actuatable valve
80.1 first valve port of the manually actuatable valve
80.2 second valve port of the manually actuatable valve
80.3 exhaust port of the manually actuatable valve
80A first valve position of the manually actuatable valve
80B second valve position of the manually actuatable valve
81 3/2-way valve
82 manual actuating means
83 push-pull element
84 pneumatic actuating means
84.1 pneumatic switching inlet
85 indicator means
86 pneumatic switching path
87 pneumatic operating supply line
89 pneumatic operating control line
90 electrically controllable switching valve
90.1-90.3 first to third switching-valve port
90A first switching-valve position
90B second switching-valve position
91 3/2-way valve
92 further pressure sensor
100 electropneumatic trailer parking-brake module
102 electropneumatic trailer parking-brake system
106 trailer service-brake system
110 trailer operating unit
112 assembly
114 housing
120 electronic operating element
126 electrical operating control line
201 trailer
202 commercial vehicle
203 towing combination
220 control end coupling
222 service-brake end coupling
224 reservoir end coupling
226 electrical supply end coupling
230 compressed-air reservoir
240 trailer service-brake module
250 pneumatic trailer reservoir line
250.1 trailer reservoir-line branch
252 non-return valve
260 pneumatic service-brake line
262 trailer control line
300 electronic control unit
320 electrical interface
330 further electronic control device
510 wheel
520 combination brake cylinder
522 service-brake chamber
524 spring-brake chamber, spring-brake cylinder
526 service-brake cylinder
FA fault
FS electric power failure
pF spring-actuator pressure
pL release pressure
pS control pressure
pU switch-over pressure
pV reservoir pressure
RA axial direction
RV supply direction
SB operating signal
SBE electrical operating signal
SBP pneumatic operating signal
U environment

1. An electropneumatic trailer parking-brake system for a trailer, the electropneumatic trailer parking-brake system comprising:
an electropneumatic trailer parking-brake module configured for releasing or engaging the electropneumatic trailer parking-brake system in dependence upon an operating signal;
said electropneumatic trailer parking-brake module having a reservoir port, a parking brake port, a main-valve unit, a pilot-valve unit, a pilot-valve arrangement, and an electronic control unit;
said reservoir port being configured to receive a reservoir pressure;
said parking-brake port being for connecting at least one parking-brake cylinder;
said main-valve unit being configured to receive the reservoir pressure and to deliver a spring-actuator pressure at said parking-brake port in dependence upon a control pressure present at a control port;
said pilot-valve arrangement being configured to receive the reservoir pressure for providing the control pressure;
said electronic control unit being configured to receive the operating signal in a form of an electrical operating signal for releasing or engaging the electropneumatic trailer parking-brake system, and to provide an electrical switching signal to said pilot-valve arrangement in dependence upon the operating signal; and,
said pilot-valve arrangement being configured to provide the control pressure in dependence upon the electrical switching signal.

2. The electropneumatic trailer parking-brake system of claim 1 further comprising a trailer operating unit configured to provide the operating signal.

3. The electropneumatic trailer parking-brake system of claim 2, wherein said trailer operating unit has an electronic operating element that is connected or connectable in a signal-carrying manner to said electrical control unit for providing the electronic operating signal.

4. The electropneumatic trailer parking-brake system of claim 3, wherein said electronic operating element includes a parking-brake switch.

5. The electropneumatic trailer parking-brake system of claim 2, wherein said trailer operating unit has a pneumatic operating element pneumatically connected or connectable to said electropneumatic trailer parking-brake module for providing a pneumatic operating signal.

6. The electropneumatic trailer parking-brake system of claim 2 further comprising a pressure sensor pneumatically connected to said reservoir port for sensing the reservoir pressure delivered at said reservoir port.

7. The electropneumatic trailer parking-brake system of claim 1, wherein said trailer operating unit is an assembly including said electronic operating element and an integral or modular housing.

8. The electropneumatic trailer parking-brake system of claim 5, wherein:
at least one of said electropneumatic trailer parking-brake system and said pneumatic operating element includes a manually actuatable valve for providing the pneumatic operating signal, said manually actuatable valve has a manual actuator for switching over said manually actuatable valve at least between a first valve position and a second valve position; and,
a first valve port is configured to receive the reservoir pressure and a second valve port is pneumatically connected to said control port for providing the pneumatic operating signal in a form of a release pressure, wherein, when said manually actuatable valve is in said first valve position, said first valve port is pneumatically connected to said second valve port for applying the reservoir pressure as the release pressure to said control port.

9. The electropneumatic trailer parking-brake system of claim 8, wherein:
said manually actuatable valve is a 3/2-way valve having an exhaust port that exhausts air into an environment; and,
said 3/2-way valve is configured to be switched over between said first valve position and said second valve position, wherein in said first valve position said first valve port is pneumatically connected to said second valve port, and in said second valve position said second valve port is pneumatically connected to said exhaust port.

10. The electropneumatic trailer parking-brake system of claim 8, wherein said manual actuator includes a push-pull element configured to be moved in an axial direction for actuating said manually actuatable valve.

11. The electropneumatic trailer parking-brake system of claim 8, wherein:
said manually actuatable valve has a pneumatic actuator having a pneumatic switching inlet for receiving a switch-over pressure via a pneumatic switching path; and,
said pneumatic actuator is configured to switch over said manually actuatable valve at least from said first valve position to said second valve position in dependence upon the switch-over pressure.

12. The electropneumatic trailer parking-brake system of claim 11, wherein:
said pneumatic switching path is connected to a pilot path for receiving the control pressure; and,
said pilot path pneumatically connects said pilot-valve arrangement and said control port.

13. The electropneumatic trailer parking-brake system of claim 11, wherein:
an electrically controllable switching valve is arranged in said pneumatic switching path for controllably connecting and closing said pneumatic switching path; and,
said pneumatic switching path is pneumatically connected to said parking-brake port for receiving the spring-actuator pressure; or,
said pneumatic switching path is pneumatically connected to said reservoir port for receiving the reservoir pressure.

14. The electropneumatic trailer parking-brake system of claim 8 wherein at least one of:
said second valve port of the manually actuatable valve is pneumatically connected to said control port via an anti-compound port; and,
said second valve port is pneumatically connected to said anti-compound port via a select-high release valve such that whichever of said second valve port and said anti-compound port at which a higher pressure is present is connected to said control port.

15. The electropneumatic trailer parking-brake system of claim 14, wherein said second valve port of said manually actuatable valve is pneumatically connected to said control port via said pilot-valve arrangement.

16. The electropneumatic trailer parking-brake system of claim 1, wherein said pilot-valve arrangement has a bistable valve.

17. The electropneumatic trailer parking-brake system of claim 1, wherein said pilot-valve arrangement has a monostable holding valve that in a non-activated state switches into a release position.

18. A trailer comprising at least one parking-brake cylinder and the electropneumatic trailer parking-brake system of claim 1.

19. The trailer of claim 18, wherein the trailer is for a commercial vehicle.

20. A trailer comprising at least one parking-brake cylinder and the electropneumatic trailer parking-brake system of claim 2, wherein said trailer operating unit is arranged on the trailer.

21. A towing combination comprising a commercial vehicle and the trailer of claim 18, wherein a trailer operating unit is arranged on said commercial vehicle.
